(19) United States
(12) Patent Application Publication
(10) Pub. No.: US 2017/0350543 A1
(43) Pub. Date: Dec. 7, 2017

(54) Hose Swivel Coupling System

(71) Applicant: Brad Lillmars, Cave Creek, AZ (US)

(72) Inventor: Brad Lillmars, Cave Creek, AZ (US)

(21) Appl. No.: 15/477,430

(22) Filed: Apr. 3, 2017

Related U.S. Application Data
(63) Continuation-in-part of application No. 15/174,148, filed on Jun. 6, 2016.

(51) Int. Cl. F16L 27/047; B05B 15/06; F16L 17/02; F16L 27/02

(52) U.S. Cl. CPC F16L 27/047; F16L 27/023; B05B 15/067; F16L 17/02

(57) ABSTRACT

A hose swivel coupling apparatus comprising a first tubular connector defining a concave internal cavity and comprising a female threaded portion; a second tubular connector comprising a male threaded portion and an inlet hole; and a pivot device, further comprising a ball end structured to fit within said concave internal cavity and a hollow tubular extension coupled to said second tubular connector; and a gasket fitted inside said first tubular connector providing a seal between a hose threadably attached to said first tubular connector and said pivot device ball end.

### CROSS-REFERENCE TO RELATED APPLICATIONS

This application is a Continuation-in-Part of Continuation application Ser. No. 15/174,418 originally filed Jun. 6, 2016, entitled “SWIVELING PLUMBING FITTING”, which is a Continuation of application Ser. No. 14/696,273 originally filed Apr. 24, 2015, the contents all of which are incorporated herein by this reference and are not admitted to be prior art with respect to the present invention by the mention in this cross-reference section.

### FIELD OF THE INVENTION

The present invention relates generally to swivel couplings, and more specifically, to a hose swivel coupling apparatus capable of rotation in multiple planes and using a combination of a gasket and water pressure flowing through the hose swivel coupling to provide a fluid-proof seal.

### SUMMARY

In various embodiments, a hose swivel coupling apparatus and system in accordance with the present disclosure comprises a first tubular connector, a second tubular connector, a pivot device, and a gasket. The first tubular connector further comprises a concave internal cavity and a female threaded portion. The second tubular connector further comprises a male threaded portion and an inlet hole. The pivot device further comprises a ball end and a hollow tubular extension. The hollow tubular extension is preferably coupled to the second tubular connector in the inlet hole and the ball end is configured to fit within the concave internal cavity of the first tubular connector. The gasket preferably fits within the first tubular connector such that the gasket provides a seal between the first tubular connector and the hose being coupled to the hose swivel coupling apparatus.

The hose swivel coupling is designed such that when fluid pressure is applied through the first tubular connector the combination of the gasket and the fluid pressure creates a fluid proof seal and permits the second tubular connector to rotate in multiple planes about the first tubular connector as fluid flows through the hose swivel coupling.

In various embodiments, one or both of the first tubular connector and second tubular connector may comprise a quick disconnect fitting allowing easy coupling of a hose to the first tubular connector and a second device coupling to the second tubular connector. In other embodiments, either or both of the first tubular connector and the second tubular connector may be integral to a hose or second device.

### BRIEF DESCRIPTION OF THE DRAWINGS

FIG. 1 is a perspective view for a HOSE SWIVEL COUPLING APPARATUS according to a preferred embodiment of the present invention.

FIG. 2 is an expanded component view for a HOSE SWIVEL COUPLING APPARATUS according to a preferred embodiment of the present invention.

FIG. 3 is a side cut-away view for a HOSE SWIVEL COUPLING APPARATUS according to an alternate preferred embodiment of the present invention.

FIG. 4 is a perspective view for a HOSE SWIVEL COUPLING SYSTEM according to a preferred embodiment of the present invention.

### DETAILED DESCRIPTION OF THE INVENTION

The following description of the preferred embodiments of the invention is intended to enable someone skilled in the prior art to make and use this invention, but is not intended to limit the invention to these preferred embodiments.

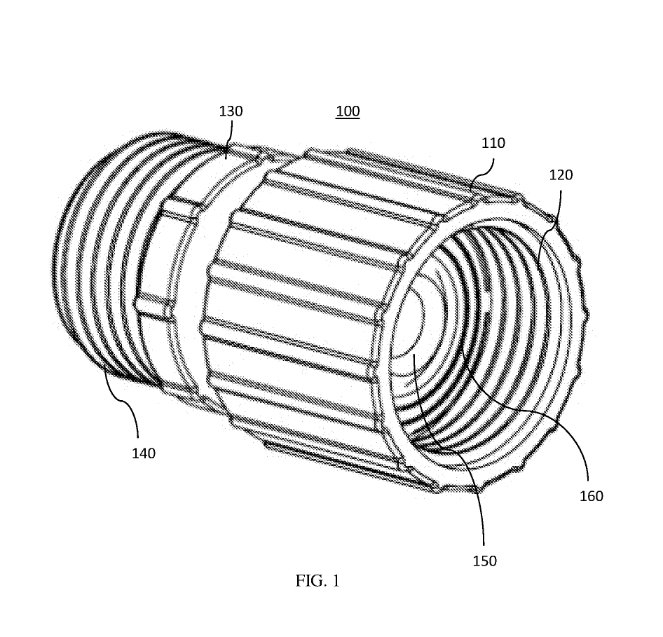

Now referring to FIG. 1, the invention described herein is a hose swivel coupling apparatus 100 preferably comprising a first tubular connector 110, further comprising a concave internal cavity and a female threaded portion 120; a second tubular connector 130, further comprising a male threaded portion 140 and an inlet hole; a pivot device 150, further comprising a ball end structured to fit within the concave internal cavity of the first tubular connector 110 and a hollow tubular extension coupled to the second tubular connector 130 at said inlet hole; and a gasket 160 fitted inside the first tubular connector 110 providing a seal between a hose threadably attached to the first tubular connector 110 and the pivot device 150 ball end.

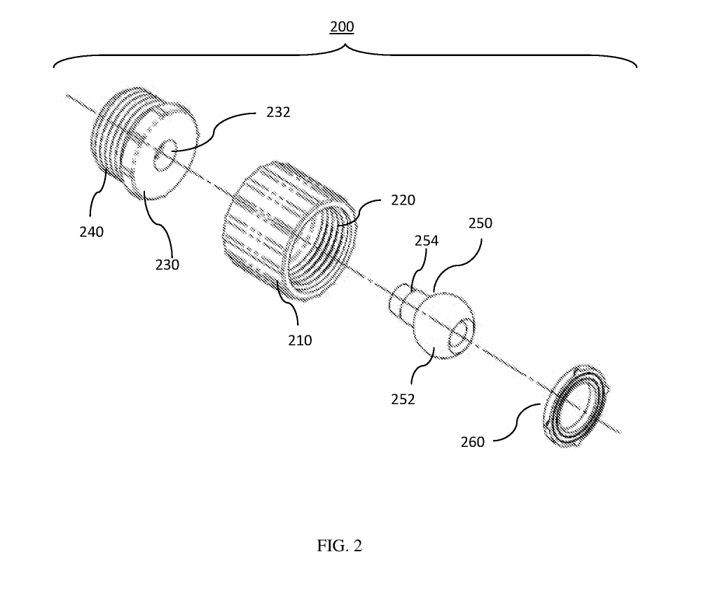

As shown in FIG. 2, the gasket 260 is preferably shaped and structured to seat within the first tubular connector 210 to provide a seal, along with fluid pressure, between a threadably coupled hose and the first tubular connector 210. The gasket 260 is preferably flat with a center bore 262 extending axially through the gasket allowing fluid to enter the first tubular connector 210 and flow through the bore 262 in the gasket and into the pivot device 250 ball end 252. Additionally, the gasket 260 preferably holds the pivot device ball end 252 in place within the concave internal cavity of the first tubular connector 210.

The gasket 260 is preferably made from a semi-rigid silicon-based material, or rubber, and is generally flat and circular in shape. However, other materials suitable to provide similar characteristics are considered. In an alternate embodiment, the gasket 260 is formed as part of, and integral to, the first tubular connector 210.

The hose swivel coupling apparatus components, the first tubular connector, the second tubular connector, and/or the pivot device may preferably be comprised of a metal material, such as brass or stainless steel, or a polymeric material, such as PVC or other rigid high density copolyester plastic, or any combination thereof. Although described with respect to specific materials, any material with suitable strength and smoothness for the hose swivel coupling apparatus to operate under fluid pressure provided by fluid flow is within the scope of the preferred embodiment.

As further shown in FIG. 2, the first tubular connector 210 preferably comprises a female threaded portion 230 preferably configured with standard female garden hose threads (GHF) to receive and couple the hose swivel coupling apparatus to a hose with complementary male garden hose threads. Additionally, a portion of the exterior surface 216 of the first tubular connector 210 preferably comprises a textured surface to allow for improved grip and easier manipulation of the first tubular connector 210 when threadably coupling the hose swivel coupling apparatus to a hose. The textured surface is preferably comprised of a plurality of linear ribs running the length of the first tubular connector. Alternately, the textured surface is comprised of a rough knurling pattern etched, or carved, into the exterior surface of the first tubular connector.

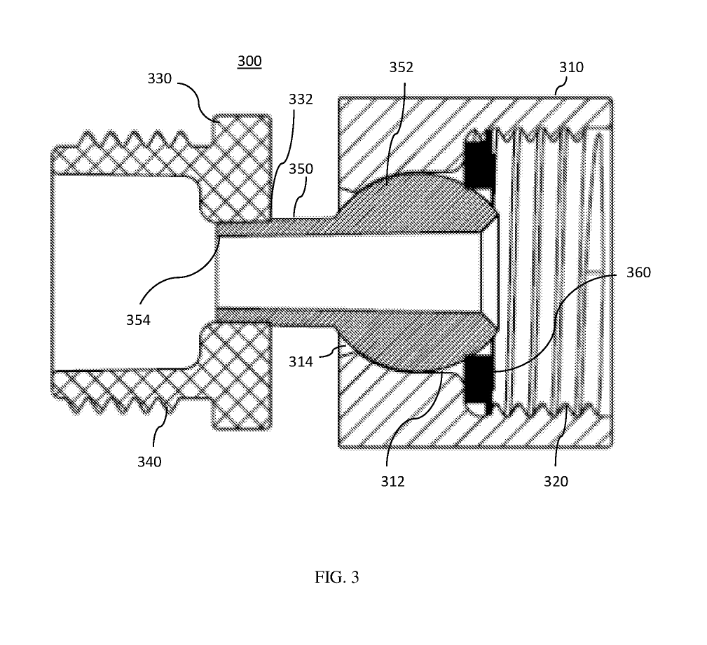

As shown in FIG. 3, the first tubular connector 310 further comprises a concave internal cavity 312, where the surface of the concave internal cavity 312 is preferably configured in a concave shape structured to match the shape of the pivot device ball end 352. The first tubular connector 310 preferably further comprises an outlet hole 314 opposite the female threaded portion 320. The outlet hole 314 is sized to accept the distal end of the hollow tubular extension 354 of the pivot device 350 but not allow the ball end to fit through. The pivot device ball end 352 is preferably encapsulated within the concave internal cavity 312 such that the ball end is allowed to rotate freely within the concave internal cavity 312 while the hollow tubular extension 354 connects the ball end to the second tubular connector 330 at the second tubular connector inlet hole 332. The surface of the exterior of the ball end and the interior of the concave internal cavity where the two meet are preferably smooth to allow the free rotation of the ball end within the concave internal cavity as fluid pressure flows through the hose swivel coupling apparatus 300.

As further shown in FIG. 3, the second tubular connector 330 comprises a male threaded portion 340 and a flat surface with an inlet hole 332 opposite the male threaded portion 340. The male threaded portion 340 is preferably configured with standard male garden hose threads (GHM) to receive and couple the second tubular connector 330 to a second device with complementary female threads, such as a hose accessory device or a second hose. A portion of the exterior surface of the second tubular connector 260 preferably comprises a textured surface to allow for improved grip and easier manipulation of the second tubular connector 330 when threadably coupling the hose swivel coupling apparatus 300 to a second device. Like the textured surface of the first tubular connector 310, the textured surface is preferably comprised of linear ribs running the length of the first tubular connector. Alternately, the textured surface is comprised of a rough knurling pattern etched, or carved, into the exterior surface of the first tubular connector.

As further shown in FIG. 3, the hose swivel coupling apparatus 300 comprises a pivot device 350 coupled to and in fluid communication with the first tubular connector 310 concave internal cavity 320. The pivot device preferably comprises a ball end 352 and a hollow tubular extension 354. The longitudinal bore of the hollow tubular extension 354 continues through the ball end 352. As fluid flows through the first tubular connector 310, the fluid enters the pivot device ball end 352 and flows through the hollow tubular extension 354 and out the second tubular connector 330 into the garden hose accessory threadably attached to the second tubular connector 330 male threaded portion 340.

As further shown in FIG. 3, the pivot device ball end 352 preferably comprises a chamfered opening. The chamfered opening of the ball end 352 directs the fluid flowing into the first tubular connector 310 to flow into the pivot device 350 and still allow the second tubular connector 330 to swivel about the first tubular connector 310. The chamfered opening also produces a venturi effect where the fluid pressure is increased as it flows through the pivot device.

As further shown in FIG. 3, the pivot device hollow tubular extension 354 is preferably structured and arranged to fit into the inlet hole 332 of the second tubular connector 330. The pivot device ball end 352 allows the second tubular connector 330 to rotate through multiple planes in relation to the first tubular connector 310. The combination of the gasket 360 and fluid pressure flowing into the first tubular connector 310 provides the fluid-proof seal within the concave internal cavity 312 by pushing the pivot device ball end 352 against the inside surface of the concave internal cavity 312 preventing excess fluid from leaking out of the hose swivel apparatus 300.

Alternately preferably, the first tubular connector may further comprise a quick disconnect fitting. In such embodiments, a hose will preferably comprise a quick disconnect fitting that is complimentary to the quick disconnect fitting of the first tubular connector. Alternately preferably, any structure suitable for coupling the first tubular connector in a permanent or temporary manner with a hose is within the scope of the present invention.

Alternately preferably, the second tubular connector may further comprise a quick disconnect fitting. In such embodiments, a second hose or a second device will preferably comprise a quick disconnect fitting that is complimentary to the quick disconnect fitting of the second tubular connector. Alternately preferably, any structure suitable for coupling the second tubular connector in a permanent or temporary manner with a second hose or a second device is within the scope of the present invention.

In an alternate embodiment, either the first tubular connector or the second tubular connector may be integrated into a corresponding hose or second device. For example, a second device may have the second tubular connector integrated into one end, such as the inlet of a sprayer or nozzle. Additionally, the first tubular connector may be integrated into a hose outlet end.

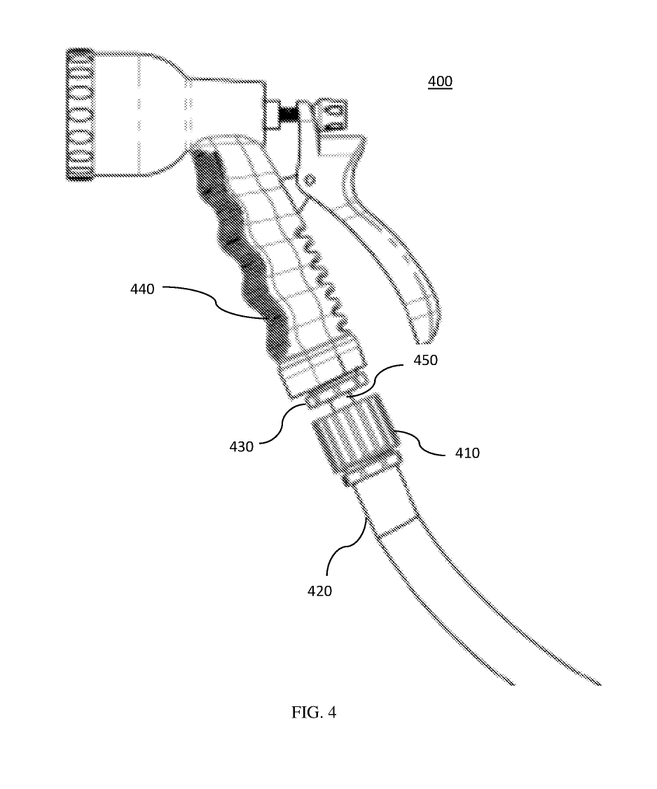

As shown in FIG. 4, a hose swivel coupling system 400 comprising: a first tubular connector 410 defining a concave internal cavity and coupled to a first hose 420; a second tubular connector 430 coupled to a second device 440; a pivot device 450, further comprising a ball end structured to fit within the concave internal cavity and a hollow tubular extension mated to the second tubular connector; and a gasket fitted inside the first tubular connector 410 providing a seal between the first hose 420 coupled to the first tubular connector 410 and the pivot device 450 ball end. The second device could be a second hose or an accessory such as a hand-held sprayer.

The first tubular connector 410, the second tubular connector 430, and the pivot device 450 are as described above in the hose swivel coupling apparatus. All of the features and details of the hose swivel coupling apparatus described above are incorporated into the hose swivel coupling system 400.

Preferably, the first tubular connector 410 preferably further comprises standard female hose threads, such as garden hose threads (GHF) and is threadably coupled to a typical hose 420 or garden hose. Also, the second tubular connector 430 preferably further comprises standard male hose threads, such as male garden hose threads (GHM), and is preferably threadably coupled to a second device 440, such as a second hose or a hose accessory. Spray accessories could include, but are not limited to, spray nozzles, hand sprayers, wand sprayers, and wand brushes.

In an alternate embodiment, the first tubular connector is integral to the first hose. In this alternate embodiment, the first tubular connector is permanently coupled to the first hose. In this embodiment, a user would only have to threadably couple the second tubular connector to a second hose inlet or an accessory inlet, such as a spray nozzle.

Alternately, the second tubular connector is integral to the second hose or the second device. In this embodiment, the second tubular connector would be permanently coupled to the inlet end of a second hose or the the inlet end of an accessory, such as a spray nozzle, wherein a user would only have to threadably couple the first tubular connector to the outlet end of a first hose.

Alternately preferably, the first tubular connector may further comprise a quick disconnect fitting. In such embodiments, a first hose will preferably comprise a quick disconnect fitting that is complimentary to the quick disconnect fitting of the first tubular connector. Alternately preferably, any structure suitable for coupling the first tubular connector in a permanent or temporary manner with a first hose is within the scope of the present invention.

Alternately preferably, the second tubular connector may further comprise a quick disconnect fitting. In such embodiments, a second device will preferably comprise a quick disconnect fitting that is complimentary to the quick disconnect fitting of the second tubular connector. Alternately preferably, any structure suitable for coupling the second tubular connector in a permanent or temporary manner with a second device is within the scope of the present invention

Several characteristics and advantages have been set forth in the preceding description, including various alternative embodiments together with details of the structure and function of the devices and/or systems. The disclosure is intended as illustrative only and, as such, is not intended to be exhaustive or limiting. It will be evident to those skilled in the art that various modifications may be made, especially in matters of structure, materials, elements, components, shapes, sizes, and arrangements of parts including combinations within the principles described herein, to the full extent indicated by the broad, general meaning of the terms in which the appended claims are expressed. To the extent that these various modifications depart from the spirit and scope of the appended claims, they are intended to be encompassed therein.

We claim:

1. A hose swivel coupling apparatus comprising:
a first tubular connector defining a concave internal cavity and comprising a female threaded portion;
a second tubular connector comprising a male threaded portion and an inlet hole; and
a pivot device, further comprising a ball end structured to fit within said concave internal cavity and a hollow tubular extension coupled to said second tubular connector; and
a gasket fitted inside said first tubular connector providing a seal between a hose threadably attached to said first tubular connector and said pivot device ball end.

2. The hose swivel coupling apparatus of claim 1, wherein said female threaded portion further comprises female garden hose threads.

3. The hose swivel coupling apparatus of claim 1, wherein said male threaded portion further comprises male garden hose threads.

4. The hose swivel coupling apparatus of claim 1, wherein said first tubular connector, said second tubular connector, and said pivot device are comprised of a polymeric material.

5. The hose swivel coupling apparatus of claim 1, wherein said first tubular connector, said second tubular connector, and said pivot device are comprised of a metallic material.

6. The hose swivel coupling apparatus of claim 1, wherein said first tubular connector further comprises a female quick disconnect mechanism.

7. The hose swivel coupling apparatus of claim 1, wherein said second tubular connector further comprises a male quick disconnect mechanism.

8. The hose swivel coupling apparatus of claim 1, wherein said gasket is integral to said first tubular connector.

9. The hose swivel coupling apparatus of claim 1, wherein said pivot device is integral to said second tubular connector.

10. A hose swivel coupling system, comprising:
a first tubular connector defining a concave internal cavity and coupled to a first hose;
a second tubular connector coupled to a second device;
a pivot device, further comprising a ball end structured to fit within said concave internal cavity and a hollow tubular extension mated to said second tubular connector; and
a gasket fitted inside said first tubular connector providing a seal between said first hose coupled to said first tubular connector and said pivot device ball end.

11. The hose swivel coupling system of claim 10, wherein said second device is a second hose.

12. The hose swivel coupling system of claim 10, wherein said second device is a hand-held sprayer.

13. The hose swivel coupling system of claim 10, wherein said first tubular connector is integral to said first hose.

14. The hose swivel coupling system of claim 10, wherein said second tubular connector is integral to said second device.

15. The hose swivel coupling system of claim 10, wherein said first tubular connector further comprises female garden hose threads.

16. The hose swivel coupling system of claim 10, wherein said second tubular connector further comprises male garden hose threads.

17. The hose swivel coupling system of claim 10, wherein said first tubular connector further comprises a female quick disconnect mechanism.

18. The hose swivel coupling system of claim 10, wherein said second tubular connector further comprises a male quick disconnect mechanism.
